(19) United States
(12) Patent Application Publication
(10) Pub. No.: US 2007/0284239 A1
(43) Pub. Date: Dec. 13, 2007

(54) C-C special coke tower

(75) Inventor: Jicheng Chen, Loma Linda, CA (US)

Correspondence Address: ZHENGFANG CUI, 25526 REDLANDS BLVD., SPACE 157, LOMA LINDA, CA, 92354, US

(73) Assignee: Zhengfang Cui, Loma Linda, CA (US)

(21) Appl. No.: 11/534,670

(22) Filed: Sep. 24, 2006

Related U.S. Application Data
(60) Provisional application No. 60/804,437, filed on Jun. 11, 2006.

(51) Int. Cl. B01D 3/00; B01D 3/32

(52) U.S. Cl. 202/102; 202/239

(57) ABSTRACT

All the traditional coke towers are lower skirt supporting structure, which makes the heat fatigue of the tower under high temperature inevitable. The weld crack on the lower skirt and the expansion and deformation at the lower part of the tower will occur within several years. The working efficiency and lifespan of the coke tower are severely restrained. Provided is a new design of coke tower which can greatly improve the performance of the coke tower under the existing technique condition. The skirt support is raised higher, the coke stuffing segment is suspended, and the bearing force mode is changed at the coke stuffing segment. Additionally, a jacket is added to the outer wall of the coke stuffing section of the tower. The new design significantly improves the efficiency of the coke tower, and the lifespan of the tower is greatly extended.

### CROSS-REFERENCE TO RELATED APPLICATION

This application claims the priority of provisional application No. 60804437, filed Jun. 11, 2006.

### 1. TECHNOLOGY BACKGROUND

Nowadays, the delayed Coker of refinery in the petrochemical industry is the first choice for the heavy oil deep processing in the world. The coke tower is the key equipment in the delayed Coker.

1) Present Structure

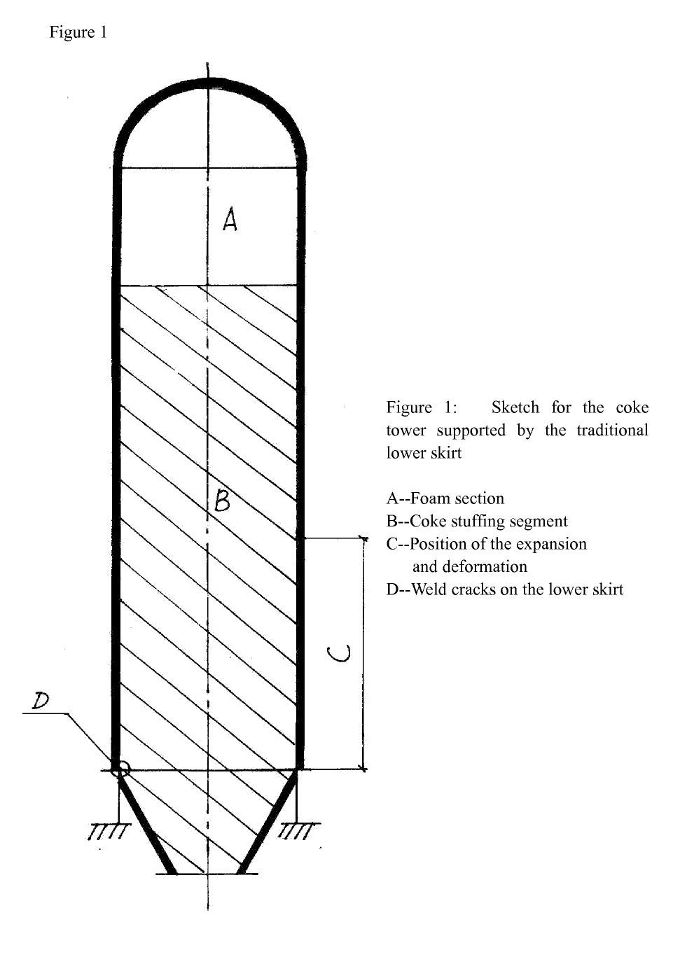

All the traditional coke towers are lower skirt supporting structure, see FIG. 1.

2) Running Damage

Due to the characteristics of the coke tower, such as “high temperature, intermittence, recycle, the high temperature fatigue and creep”, after running for several years, the weld crack on the lower skirt and the expansion and deformation at the lower part of the column will be occurred. The running efficiency and service life of the coke tower will be restrained seriously, and a great deal of funds will be wasted by these running damages. This is also a big “persistent ailments” of the equipments in the petrochemical industry.

3) The Reasons for This Damage

There are two main reasons for the running damage: The heat fatigue of the column with high temperature and the traditional design with mistakes.

In the traditional lower skirt supporting structure, the heat expanding upward of the column is restrained by the tower weight and the stuffing weight under high temperature, so that a downward axial compressing force F1 is created; the axial temperature is the lower part of the column to be higher than the upper part, so the upper part of the column resists the expanding upward from the lower part of the column, therefore, an axial compressing force F2 will be created; when the column is cooled by water, an axial compressing force F3 of outer wall will be created by the temperature difference of the inner and outer walls of the column; a compressing force F4 will be created on the cross section of the column by the tower weight and the stuffing weight. Especially during the column is cooled by water, the cooling water temperature is very low, along with rise of water level, because the outer wall of column that is equal to the water level is thicker, so the radial temperature difference of the inner and outer wall of the column is bigger, and several kinds of axial compressing forces are acted on it synthetically, here, a huge compressing stress will be created on the outer wall of column. The irreversible deformation will be produced on the outer wall of column, it will result in the expansion of the column and the weld crack on the lower skirt.

When the coke is removed, the high pressure water will give an impact to the inner wall of the column, so an additional bending stress will be produced on the inner wall, and the damage of the lower skirt will be accelerated.

The greatest axial compressing force appears at the lower part of coke stuffing segment and the outer wall of the column, the column wall temperature is also the highest in this place, and heat intensity, creep limit and the permanent intensity of the material are lower than other places, under the action of compressing force and high temperature, the lower part of the coke tower begin to expand and deform after running for several recycles.

The surface shape and the quality can greatly influence the fatigue limit of the component. If the longitude of the column surface is not continuous, the permanent intensity of the column will be lowered consumedly, and the expansion and deformation of the column will be accelerated. The irreversible deformation of the column will be increased continuously by the vicious cycle, and the service life of the column will be decreased consumedly.

4) General Solutions
a) Improving the quality of the material;
b) Frequently replacing the column in order to keep its high efficient running;
c) Lowering the running efficiency in order to prolong the service life of the column;
d) Whole lower skirt will be forged;
e) The quantity of circumferential weld should be decreased on the lower part of the column;
f) The column welds, especially the circumferential welds on the lower part of the column should be grinded as smooth as the base metal.

### 2. THE CORE OF THE TECHNIQUE INNOVATION

1) Raising the Skirt

Under the working condition of the equipment is not changed, the skirt is supported highly, the coke stuffing segment will be suspended, and the bearing force mode will be changed at the coke stuffing segment of the column.
a) The coke stuffing segment of the column will be expanded downward freely;
b) The temperature of the lower part of column is higher than the upper part, so the lower part of the column will not restrain the expanding downward from the temperature of the upper part of the column;
c) The column weight and the stuffing weight will produce a axial stretching stress in the coke stuffing section of the column;
d) The axial stretching stress will be also caused by pressure inside the tower.

Compressing force may cause the component curving, such as the expansion and deformation of the traditional coke tower is produced by compressing stress, stretching force will never make the component bending, and it is possible to appear that phenomenon, the more the component is stretched, the more the component is long.

Under this stretching force:
a) Remove the source of expansion in the lower part of the column - compressing force;
b) Lower the axial stress in the cross section of the coke stuffing segment;
c) Remove the “vicious cycle” as mentioned above, see 1-- 3).

2) Adding a Jacket

Increase a jacket at the outer wall of the coke stuffing section of the tower, connect the gas jacket made of steel to steel bracket.

Set some breeze doors at the lower part of the jacket, set some blowhole to release pressure at the upper part of the jacket, preserve heat at jacket outer wall.

Control the temperature of the outer wall of the tower by adjusting the breeze doors at the lower part of the jacket.

During coke stuffing stage of the tower, close the breeze doors, the air thermal conductivity is very low, having good heat preservation action; during the water cooling off stage, opening the jacket breeze door, cold wind ascend, which has the same direction as the cooling off water, the inner wall is cooled off by water, the outer wall by wind, this makes the temperature of outer wall and inner wall of the tower ascend and descend synchronously, lowers the temperature difference of inner and outer the wall of the tower, significantly decrease the axial force caused by the temperature difference.

3) The Reason There are Not Cracks in the Weld of the Upper Skirt with High Support
a) The temperature of the lower part the foam segment is 20-30° C. lower than that of the lower skirt of the traditional coke tower;
b) Compared with the near 30 m high of traditional lower skirt of tower, the upper skirt of tower has only a foam segment of 4-5 m high; the heat expansion of the later is much smaller than the former.
c) Compared with the traditional lower skirt of tower, there is no coke stuff but only foam in the section above the skirt in the upper skirt tower, so the compressing force caused by swelling restriction is much smaller than the traditional one.
d) After the examination of useless traditional coke towers, we found that the transformation of the coke stuffing segment of the tower is less than 10 m, but the upper skirt is 17-20 m high, that means from the top of coke stuffing section to the lower part of the foam segment, there is no swell or transformation at all.
e) In the coke removing stage of the lower skirt coke tower, as the water-powered cutter lifts up, the arm of force lengthens too. At the upper part of the coke stuffing section, the arm reaches to its biggest extend, the high pressure water then has the biggest moment to the tower, and it also has the greatest force to the lower skirt weld.
The stuffing segment contains more coke than other places in the tower, there is about 1,000 tons of coke in the stuffing segment, when the coke is removed by the high pressure water, and the high pressure water has very little influence to the tower after raising the upper skirt support. As the water-powered cutter moves up, the arm of force shortens gradually, the additional moment also descend gradually, so the upper skirt supporting coke tower suffers less stress than traditional coke tower in the coke removing stage.
f) In order to avoid vibration caused by using high pressure water in the coke removing stage of the upper skirt coke tower, a flexible still non-fixed support is set at the lower part of the tower, during the stages of heating, feeding and cooling off, the coking tower hang in the air and swell freely, in the coke removing stage, the flexible still non-fixed support descends to the ground and support the tower from below, that really improve the inherence frequency of the tower and reduce the vibration of the tower

### 3. THE PRACTICE OF THE TECHNIQUE INNOVATION

1) Expands the diameter of the foam section.
2) Raises the skirt to the under part of the foam section of the tower
3) Embed the steel bracket into the reinforced concrete foundation of the tower; the steel bracket and the removing coke frame are designed synthetically. The skirt is fixed on the steel bracket.
4) A telescopic, still and unfixed support will be installed at the lower part of the tower for using intermittently.
5) A jacket should be added at the outer wall of the coke stuffing segment of the tower, heat insulating material should be installed on the outer wall of the jacket, several air doors should be installed at the lower part of the jacket, and several pressure release holes should be installed at the upper part of the jacket.

### 4. THE SIGNIFICANCE OF THE TECHNIQUE INNOVATION

1) Under the existing technique condition, it significantly shortens the single recycle time, improves the efficiency of the coke tower greatly.
2) The bearing stress on the tower will have been improved largely, the service life of the tower will be increased greatly.
3) The production efficiency of the coke tower will be lifted largely, the service life of the tower's column will be extended, great deal of funds will be saved, and a huge economic profit will be acquired.
4) The innovation not only solves the equipments problem, but also brought a benefit if reducing the coke in the fractionating tower. When the oil air inside the tower rise to the diameter-expanding part of the foam segment in the coking tower feeding process, the cross section of the tower extend suddenly, the oil air ascend velocity slow down, the coke powder in the oil air enters in the fractionating tower is then greatly reduced.
5) The jacked outside the coke stuffing section is cooled by air, ventilate naturally, and don't need any additional energy.

### 5. ILLUSTRATION

FIG. 1: Sketch for the coke tower supported by the traditional lower skirt.

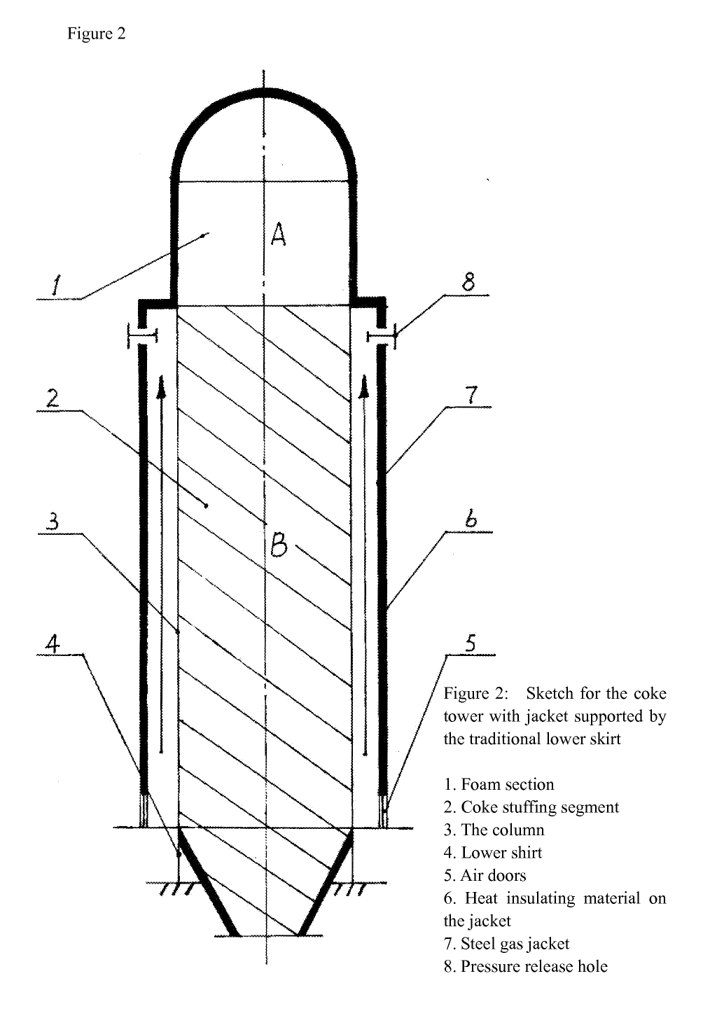

FIG. 2: Sketch for the coke tower with jacket supported by the traditional lower skirt.

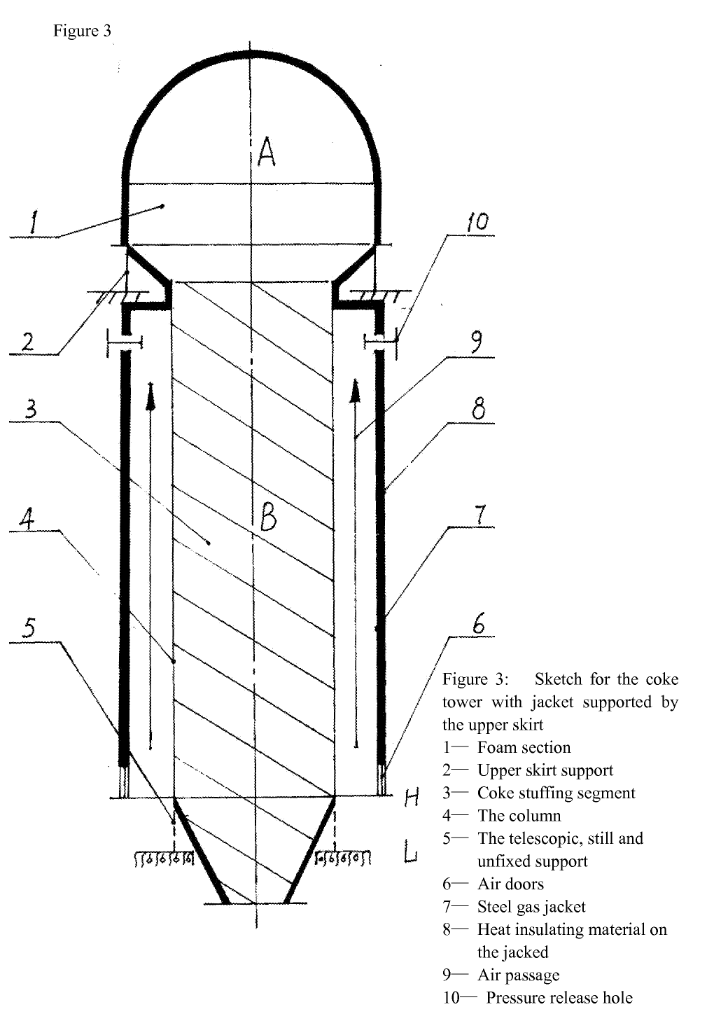

FIG. 3: Sketch for the coke tower with jacket supported by the upper skirt.

What is claimed is:

1) A coke tower wherein said adding a jacket at the outer wall of the coke stuffing section of the tower.

2) A coke tower of claim 1, wherein said adjusting the temperature of the outer wall of the tower.

3) A coke tower wherein said expanding the diameter of the foam section.

4) A coke tower of claim 3, wherein said raising the skirt to the under part of the foam section of the tower.

5) A coke tower of claim 3, wherein said setting a flexible still non-fixed support at the lower part of the tower for intermittently using.

6) A coke tower comprising two forms of the lower part of jacket:
a) setting the lower part of the jacket on the joint of tower tube and the bottom cover;
b) setting the lower part of the jacket on interface of the reinforced concrete and the steel bracket.
